(19) United States
(12) Patent Application Publication
(10) Pub. No.: US 2023/0097465 A1
(43) Pub. Date: Mar. 30, 2023

(54) Emergency Shutdown of A No-Insulation Magnet

(71) Applicants: Massachusetts Institute of Technology, Cambridge, MA (US); Commonwealth Fusion Systems LLC, Cambridge, MA (US)

(72) Inventors: Alexey RADOVINSKY, Cambridge, MA (US); Krishna Kiran Kumar UPPALAPATI, North Billerica, MA (US)

(73) Assignees: Massachusetts Institute of Technology, Cambridge, MA (US); Commonwealth Fusion Systems LLC, Cambridge, MA (US)

(21) Appl. No.: 17/911,270

(22) PCT Filed: Mar. 25, 2021
(86) PCT No.: PCT/US2021/024130

§ 371 Date: Sep. 13, 2022

Related U.S. Application Data
(60) Provisional application No. 63/000,406, filed on Mar. 26, 2020.

(51) Int. Cl. H01F 6/00; H01F 6/02; H01F 6/06

(52) U.S. Cl. CPC H01F 6/003; H01F 6/02; H01F 6/06

(57) ABSTRACT

Structures and methods enable emergency or rapid shutdown of an energized no-insulation (NI) superconducting magnet, without damage due to thermal effects of a quench. A resistive bypass wire is coupled between electrical terminals of the magnet coil, and does not pass significant current during normal magnet operation. When rapid shutdown is required, the bypass wire is cooled below its critical temperature, adding a superconducting current path in parallel with the magnet coil. A portion of the coil is then heated above its critical temperature, interrupting current flow through the coil. Hot spots near the coil leads are mitigated through the use of a conductive structure, such as copper cladding, that carries away excess heat due to the quench. This heat may be deposited in a resistive matrix, such as a steel plate, over a duration of seconds and without compromising other magnet design parameters.

### FIELD

This disclosure relates generally to discharge of a no-insulation (NI) magnet and more particularly to circuits, structures and methods for discharging an NI magnet by initiating a rapid quench in the magnet.

### BACKGROUND

Recent progress in the high temperature superconductor (HTS) technology opens multiple opportunities for utilization of superconducting magnets in various practical applications. One class of such applications is constant-field, constant-current magnets (sometimes referred to as “Direct Current magnets” or “DC magnets”).

Once charged, DC magnets operate at constant terminal current and produce constant field. At DC operating conditions, DC magnets do not experience variation of the magnetic field. This eliminates their vulnerability to effects associated with a varying magnetic field, including but not limited to hysteresis and coupling losses in a superconductor, as well as eddy-current losses both in the superconducting cable and in the supporting it structure.

### SUMMARY OF DISCLOSED EMBODIMENTS

Described are circuits, structures and methods for accomplishing fast discharge of a no-insulation (NI) magnet (sometimes referred to as a non-insulated magnet) by initiating a quench in the NI magnet (and ideally, by initiating a rapid quench in the NI magnet).

Also, described are circuits, structures and methods for adding elements to a DC magnet structure to mitigate possible formation of local hot spots.

With this particular arrangement, a method for inducing quench in an NI magnet is provided. In embodiments, a quench is rapidly induced. The shutdown time can be anywhere between instantaneous and shorter than minimum time of safe discharge (i.e., without damaging the magnet), which can be in the range of hours. In embodiments, the current shutdown time is close to zero (i.e., the NI magnet undergoes effectively instantaneous shutdown).

In accordance with the concepts, techniques, and structures disclosed herein, a first embodiment is a no-insulation (NI) magnet. The NI magnet includes a superconducting coil having electrical terminals for coupling to a power supply. Receipt of a current from the power supply through the electrical terminals causes the superconducting coil to generate a magnetic field. The NI magnet also includes a heating element disposed in proximity to a portion of the superconducting coil. Operation of the heating element causes the portion to lose its superconducting characteristic and become resistive, thereby inducing a quench of the NI magnet.

Some embodiments further include a resistive bypass wire coupled between the electrical terminals of the superconducting coil; and a cooling element disposed in proximity to the resistive bypass wire, wherein operation of the cooling element causes the resistive bypass wire to lose its resistive characteristic and become superconducting.

In some embodiments, the superconducting coil comprises a superconducting cable wound against itself without turn-to-turn insulation to form a wound layer.

In some embodiments, the superconducting coil comprises a plurality of wound layers in a layer-wound arrangement.

Some embodiments further include a layer of insulation disposed between respective ones of the plurality of wound layers in the layer-wound arrangement.

In some embodiments, the superconducting coil comprises a plurality of wound layers stacked in a pancake-wound arrangement.

Some embodiments further include a layer of insulation disposed between adjacently-stacked wound layers.

In some embodiments, the superconducting coil comprises a superconducting wire wound in a groove of a structural shell.

In some embodiments, the superconducting coil comprises a plurality of superconducting wires, each superconducting wire wound in a groove of a respective structural shell, the structural shells arranged in a layer-wound arrangement.

Some embodiments further include a layer of insulation disposed between respective ones of the structural shells.

In some embodiments, the superconducting coil comprises a plurality of superconducting wires, each superconducting wire wound in a groove of a respective structural shell, the structural shells stacked in a pancake-wound arrangement.

Some embodiments further include a layer of insulation disposed between adjacently-stacked structural shells.

In some embodiments, the superconducting coil comprises a high temperature superconductor.

Some embodiments further include a conductive structure for carrying thermal energy away from the electrical terminals during an induced quench of the NI magnet.

In some embodiments, the conductive structure comprises a copper cladding.

In some embodiments, the conductive structure is disposed about a portion of an outside or inside perimeter of the NI magnet.

Some embodiments further include an electrically resistive matrix retaining the superconducting coil.

In some embodiments, the conductive structure is coupled to the electrically resistive matrix, and wherein the electrically resistive matrix acts as a heat sink during the induced quench of the NI magnet.

In some embodiments, the electrically resistive matrix comprises steel.

Another embodiment is a no-insulation (NI) magnet system comprising a plurality of NI magnets coupled in electrical series. Each NI magnet has a superconducting coil having electrical terminals for coupling to a power supply, wherein receipt of a current from the power supply through the electrical terminals causes the superconducting coil to generate a magnetic field. Each NI magnet also has a heating element disposed in proximity to a portion of the superconducting coil, wherein operation of the heating element causes the portion to lose its superconducting characteristic and become resistive, thereby inducing a quench of the NI magnet. Each NI magnet further has a resistive bypass wire coupled between the electrical terminals of the superconducting coil. And each NI magnet has a cooling element disposed in proximity to the resistive bypass wire, wherein operation of the cooling element causes the resistive bypass wire to lose its resistive characteristic and become superconducting.

In some embodiments, the superconducting coil of at least one of the plurality of NI magnets comprises a superconducting cable wound against itself without turn-to-turn insulation to form a wound layer.

In some embodiments, the superconducting coil of the at least one of the plurality of NI magnets comprises a plurality of wound layers in a layer-wound arrangement.

In some embodiments, the at least one of the plurality of NI magnets further includes a layer of insulation disposed between respective ones of the plurality of wound layers in the layer-wound arrangement.

In some embodiments, the superconducting coil of at least one of the plurality of NI magnets comprises a plurality of wound layers stacked in a pancake-wound arrangement.

In some embodiments, the at least one of the plurality of NI magnets further includes a layer of insulation disposed between adjacently-stacked wound layers.

In some embodiments, the superconducting coil of at least one of the plurality of NI magnets comprises a superconducting wire wound in a groove of a structural shell.

In some embodiments, the superconducting coil of the at least one of the plurality of NI magnets comprises a plurality of superconducting wires, each superconducting wire wound in a groove of a respective structural shell, the structural shells arranged in a layer-wound arrangement.

In some embodiments, the at least one of the plurality of NI magnets further includes a layer of insulation disposed between respective ones of the structural shells.

In some embodiments, the superconducting coil of at least one of the plurality of NI magnets comprises a plurality of superconducting wires, each superconducting wire wound in a groove of a respective structural shell, the structural shells stacked in a pancake-wound arrangement.

In some embodiments, the at least one of the plurality of NI magnets further includes a layer of insulation disposed between adjacently-stacked structural shells.

In some embodiments, wherein the superconducting coil of at least one of the plurality of NI magnets comprises a high temperature superconductor.

In some embodiments, the at least one of the plurality of NI magnets further includes a conductive structure for carrying thermal energy away from the electrical terminals during an induced quench of the NI magnet.

In some embodiments, the conductive structure comprises a copper cladding.

In some embodiments, the conductive structure is disposed about a portion of an outside perimeter of the NI magnet.

In some embodiments, the at least one of the plurality of NI magnets further includes an electrically resistive matrix retaining the superconducting coil.

In some embodiments, the conductive structure is coupled to the electrically resistive matrix, and wherein the electrically resistive matrix acts as a heat sink during the induced quench of the NI magnet.

In some embodiments, the electrically resistive matrix comprises steel.

Some embodiments further include a system heating element comprising heating elements disposed in proximity to respective second portions of each of the NI magnets in the plurality, wherein operation of the system heating element simultaneously causes the respective second portions to lose their superconducting characteristics and become resistive, thereby inducing a simultaneous quench of each of the NI magnets in the plurality.

Another embodiment is a method of inducing quench of a no-insulated (NI) magnet energized by a power supply, the NI magnet comprising a superconducting coil. The method includes heating a portion of the superconducting coil above its critical temperature to cause the portion to lose its superconducting characteristic and become resistive, thereby interrupting a superconducting current path through the superconducting coil.

In some embodiments, the method further includes cooling a resistive bypass wire, coupled between electrical terminals of the NI magnet, below its critical temperature to cause the resistive bypass wire to lose its resistive characteristic and become superconducting, thereby providing a superconducting current path in parallel to a superconducting current path through the superconducting coil.

In some embodiments, the cooling of the resistive bypass wire occurs before the heating the portion of the superconducting coil above its critical temperature.

In some embodiments, the cooling of the resistive bypass wire and the heating of the portion of the superconducting coil both occur within a given period of time.

Some embodiments further include turning off the power supply.

Another embodiment is a method to induce quench in a no-insulated (NI) magnet having a pair of leads. The method includes reducing a resistivity of a shunt path to substantially zero, wherein the shunt path is coupled between the pair of leads of the NI magnet; and increasing resistivity of at least one of the pair of leads of the NI magnet to a resistance value comparable to a conductor having a normal resistance characteristic.

It is appreciated that the concepts, techniques, and structures disclosed herein may be embodied in ways and using means other than described above, and thus that the above summary of embodiments is meant to be merely illustrative, not comprehensive.

### DESCRIPTION OF THE SEVERAL VIEWS OF THE DRAWING

The manner and process of making and using the disclosed embodiments may be appreciated by reference to the drawings, in which:

FIG. 1 shows a circuit including a no-insulation (NI) magnet;

FIG. 1A shows the circuit of FIG. 1 after addition of a circuit breaker, such as a switch, in the closed position;

FIG. 1B shows the circuit of FIG. 1A with the circuit breaker in the open position so that current does not flow through the NI magnet;

FIG. 2A shows a circuit including a no-insulation (NI) magnet and a bypass according to the concepts, techniques, and structures disclosed herein;

FIG. 2B shows the circuit of FIG. 2A with the bypass active, so that current does not flow through the NI magnet;

FIG. 3 shows a circuit according to an embodiment having three NI magnets and bypasses coupled in series, configured to place the central magnet into an emergency shutdown;

FIGS. 4, 4A, and 4B show, using like numbers to represent like structures, a finite element (FE) model of a superconducting magnet coil in accordance with an embodiment;

FIGS. 5, 5A, and 5B show, respectively and as functions of time, the peak temperature, generated heat, and accumulated thermal energy in a simulation of a magnet quench carried out using the finite element model of FIGS. 4-4B;

FIGS. 6 and 6A show top and bottom perspective views, respectively, of a temperature distribution in the finite element model of FIGS. 4-4B at the end of the quench;

FIG. 7 shows the FE model of FIGS. 4-4B with the addition of a conductive structure (e.g. copper cladding) for mitigating excessive local heating;

FIGS. 8, 8A, and 8B show, respectively and as functions of time, the peak temperature, generated heat, and accumulated thermal energy in a simulation of a magnet quench carried out using the finite element model of FIG. 7;

FIG. 9 shows a top perspective view of a temperature distribution in the finite element model of FIG. 7;

FIG. 10 shows time-evolution of the terminal voltage of a quench in an NI magnet;

FIG. 11 shows a cross-section of a superconducting cable according to an NI scheme;

FIG. 12 shows several turns of the superconducting cable of FIG. 11 wound into a generally rectangular shape;

FIG. 13 shows a cross-section of a magnet coil using the cable of FIG. 12 according to a further, layer-wound arrangement;

FIG. 14 shows a cross-section of a magnet coil using the cable of FIG. 12 according to a further, pancake-wound arrangement;

FIG. 15 shows a cross-section of a superconducting wire wound into a structural support having multiple grooves;

FIG. 16 shows a cross-section of a magnet coil using the structural support of FIG. 15 according to a further, layer-wound arrangement;

FIG. 17 shows a cross-section of a magnet coil using the structural support of FIG. 15 according to a further, pancake-wound arrangement;

FIG. 18 shows the layer-wound arrangement of FIG. 13 having an additional, electrically-conductive element on its outside diameter (OD);

FIG. 19 shows the layer-wound arrangement of FIG. 16 having an additional, electrically-conductive element on its outside diameter;

FIG. 20 shows the pancake-wound arrangement of FIG. 14 having an additional, electrically-conductive element on its outside diameter; and

FIG. 21 shows the pancake-wound arrangement of FIG. 17 having an additional, electrically-conductive element on its outside diameter.

### DETAILED DESCRIPTION

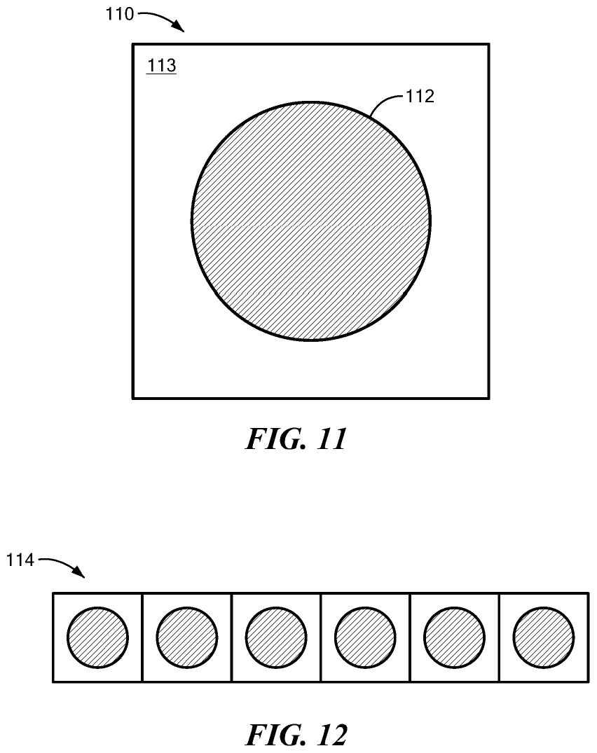

It has been recognized that winding superconducting magnets may be accomplished with the use of no-insulation (NI) techniques. An NI magnet includes a superconductor wound in a plurality of turns with a conductive (e.g., non-superconducting) electrical connection between turns. Although termed “NI” or “no-insulation,” such a magnet does not exclude the presence of insulation between turns, so long as the insulation is only partial and permits current to flow through a conductive electrical connection between adjacent turns. NI techniques may be used to provide multiple, different arrangements (or configurations) of high temperature superconductor (HTS) tapes, or cables comprised of HTS tapes. The superconductor may be disposed in an electrically continuous matrix. The superconductor may be arranged in layers or pancakes. Superconducting magnets may, however, be provided from a wide variety of different types of NI winding schemes (or magnet winding packs) including, but not limited to: (1) pancake-wound NI magnets having a cable inserted into an electrically conducting matrix; (2) pancake-wound magnets with no turn-to-turn insulation; (3) layer-wound NI magnets having a cable inserted into an electrically conducting matrix; and (4) layer-wound magnets with no turn-to-turn insulation cable. FIGS. 11-21 illustrate NI winding schemes in various magnet coils that may benefit from embodiments of the emergency shutdown concepts, techniques, and structures disclosed herein.

One significant advantage of using magnets comprised of NI windings is their passive resilience to a quench event (or more simply “a quench”). A quench refers to a transition of at least a portion of a wire having a superconducting characteristic to a wire or portion of a wire having a conventional, usually referred to as “normal,” conductive or resistive characteristic. Thus, during a quench, at least one or more portions of the superconductor may be in a “normal” (non-superconducting) state, wherein at least one or more portions of the superconductor have a normal resistance characteristic rather than the zero resistance characteristic of a superconductor. The portions of the superconductor having a normal resistance characteristic are sometimes referred to as “normal zones” of the superconductor. When normal zones appear, at least some zero resistance current pathways are no longer present, causing the current to flow through the normal zones and/or between the turns through the conductive connections between turns, with the balance of current flow between these pathways depending on their relative resistances.

In conventional DC magnet coils having insulation between the turns, local formation of a normal zone in the superconductor (i.e. the portion of the superconductor, where it quenched and became normal) may lead to an overcurrent, which has to bypass the superconductor. Since the cable is insulated, this overcurrent has to find a path which is parallel to the superconductor path within the cable. Such a path may be supplied by one or more wires having a high electrical conductivity characteristic (e.g. wires provided from copper or aluminum) which may be co-wound wires or integrated with the superconducting wire, as its part. Such wires may serve as a conduit element, commonly referred to as a stabilizer.

The current passing through the stabilizer results in heating. Such heating enlarges the normal zone until the whole magnet is quenched. Thus, without protection disposed in the normal zone, high energy can result in heating (and overheating) this locale, which may further result in destruction of the magnet.

Another possible failure mode is by breakup of insulation due to high turn-to-turn, layer-to-layer, pancake-to-pancake, or terminal voltage, which during the quench can be in the range of many kilovolts. To mitigate the adverse consequences of the quench in conventional insulated magnets (i.e. DC magnets comprising turn-to-turn insulation), sophisticated quench detection and protection schemes and equipment are often used. Such detection and protection schemes, however, increase the complexity of insulated magnets and thus increase the vulnerability of insulated magnets to failure.

On the other hand, well designed and built superconducting magnets using NI techniques are passively quench safe. The absence of the turn-to-turn insulation provides an alternative path having a resistance characteristic such that the overcurrent may flow through the alternative path (and thus around the normal zone in the superconductor). This alternative current path is in a direction which is transverse to the superconducting winding path through the normal resistivity matrix, hosting the turns of the superconducting wires, and the alternative path is provided having a resistance characteristic which is relatively low compared with the resistance characteristic of a transverse path in an insulated magnet. Thus, the alternative current path may be referred to as a relatively low-resistance, transverse, alternative current path.

Such an alternative current path formed in the superconductor normal zone creates a voltage step in a quenched turn. This voltage step, which is different from the voltage in two winding turns surrounding this turn, instigates transverse currents in the material of the resistive matrix between the turns. Joule heating of the resistive matrix heats the superconductor and facilitates propagation of the normal zone along and across the turns of the winding. This results in NI magnets having a heating distribution characteristic that is more uniform than heating distribution characteristics of an insulated magnet with respect to quench-related temperature distribution. A substantially uniform heating distribution characteristic, such as that achievable in NI magnets, advantageously permits abandoning quench detection and protection means in NI magnets. Furthermore, the relatively low transverse resistance between turns in a NI magnet reduces voltages generated during a quench event. In embodiments, such quench-related voltages rarely, if ever, exceed several volts.

Disadvantages of NI magnets are related to the same dual-current-path feature that helps with the resilience against the quench.

One particular disadvantage of the NI magnets is their long charging and discharging times. During charging or discharging, inductive magnet voltages induced by variations of current flowing along the superconductor causes transverse currents in the resistive matrix. Eddy currents heat the matrix in which the superconductor is embedded and, unless adequately cooled, this can lead to a temperature rise sufficient for quenching the NI magnet. The consequence of this effect is that charging or discharging the NI magnets without quenching may require many hours.

Long discharging times can be unacceptable in some applications utilizing NI magnets. On some occasions, the NI magnet has to be rapidly discharged (e.g. within minutes, or sometime even within seconds), for various reasons. Rapid discharge may, for example, be desirable or even necessary to allow emergency access to a facility (e.g. to allow access for emergency service personnel such as fire, medical, security enforcement, or other persons not certified for working in magnetic fields higher than specified as safe for the general public (i.e. inside a 5-gauss magnetic field line). Other situations requiring rapid discharge include avoiding consequences of mechanical failures, and following electrical failures due to the motion of unsecured magnetic parts or overstressing parts or avoiding overstressing or failure of other parts in the proximity of the magnets.

For at least the above reasons, discharge of an NI magnet by slow reduction of a transport current (i.e. the current supplied by the power supply to the NI magnet through current lead terminals) so as to shut down the magnet without inducing a quench may not be a viable, practical approach.

As the value (or amount) of the transport current approaches the critical current (such that the NI magnet is operating close to its capacity), quench may happen rapidly. The time between the moment of initiation a quench event to the moment when the current in the magnet and its stored electromagnetic energy become essentially zero may be on the order of about one minute or less. During this time interval, all electromagnetic energy stored in the NI magnet converts to thermal energy, generated in the components comprising the NI magnet, by transverse currents in the resistive matrix and in electrically conducting portions of the stabilizer that is aligned with the superconducting wire. This conversion of stored electromagnetic energy to thermal energy happens independently of whether, during this time, the transport current provided by the power supply via current leads stays constant or is shut off. The difference between the peak temperature and the final temperature distribution in the magnet is insignificantly small.

In view of the above, described herein are concepts, systems, circuits, and techniques for rapid discharge of NI magnets (i.e. to rapidly induce quench in NI magnets).

Before proceeding with a discussion of concepts, systems, circuits and techniques related to rapid discharge of NI magnets, it should be appreciated that to promote clarity in the description of the broad concepts sought to be protected herein, some example use cases are discussed below. Such use cases are not intended to be, and should not be, construed as limiting. Rather, any specific examples provided herein below are merely instructive of the broad concepts related to rapid discharge of NI magnets, and related systems, circuits and techniques. In particular, in connection with FIGS. 11-21 below are described examples which illustrate application of the rapid discharge concepts to NI magnets provided from both a layer-wound approach using superconducting cables as well as a pancake approach using superconductors disposed in plates (or shells). Such examples are intended only to facilitate clarity in the description of the broad concepts sought to be protected.

In one example below, rapid discharge and associated systems, devices and techniques are described in conjunction with an NI magnet having a so-called pancake configuration (a so-called pancake NI magnet).

In another example described below, rapid discharge and associated systems, devices and techniques are described below with respect to an NI magnet having a so-called layer-wound configuration.

After reading such examples, as well as the entire disclosure provided herein, those of ordinary skill in the art will appreciate that the rapid discharge concepts described herein may be applied to any type of NI magnet having any configuration.

In any event, as noted above, such examples are provided only to promote clarity in the description of the broad concepts sought to be protected herein and are not intended to be, and should not be, construed as limiting.

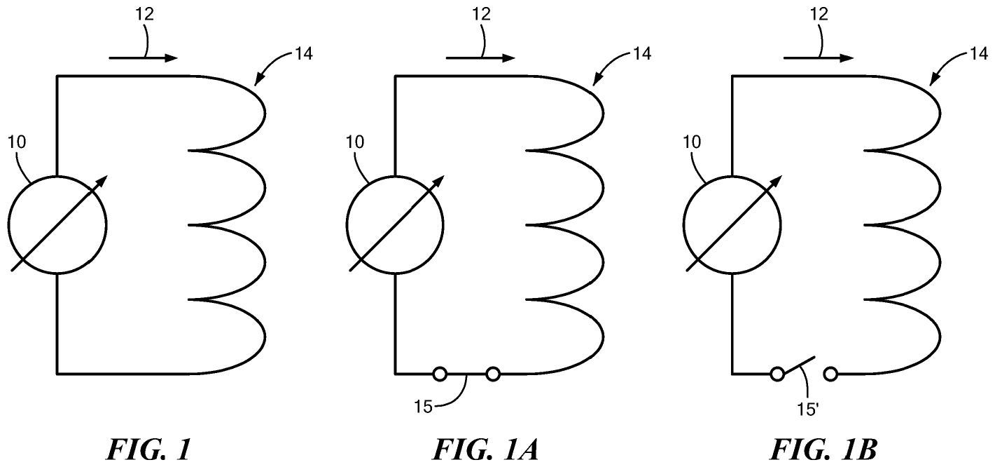

Also, after reading the description provided herein, those of ordinary skill in the art will appreciate that the described approach for rapid discharge of NI magnets may be used with any NI magnet configuration including, but not limited to those mentioned above and those described hereinbelow in conjunction with FIGS. 1-21.

Thus, described herein are systems, circuits and techniques to induce the quench by driving the transport current, provided by the power supply via terminals of current leads from its operating value to zero in a short span of time (which in the following is referred to as the “current shutdown time” or more simply, the “shutdown time”). The shutdown time can be anywhere between instantaneous and shorter than minimum time of safe (without quenching), time of discharge, which can be in the range of hours.

Instrumentally fast shutdown can be accomplished using at least several different techniques described below.

Illustratively, and with reference now to FIG. 1, a power supply 10 sources a current 12 (referred to as a “transport current”) to an NI magnet 14. One technique to accomplish rapid shutdown is by rapidly driving the transport current 12 sourced by power supply from an operating value to zero. This can be accomplished by initiating the current dump using standard current controls circuitry of the power supply.

Optionally, this can be accomplished by opening a circuit breaker 15 or via a switch 15′, as shown in FIGS. 1A and 1B, respectively. The circuit breaker 15 or switch 15′ may be opened by providing a control signal to the circuit breaker 15 or switch 15′ that opens the switch. Use of a circuit breaker, a switch, or other appropriate circuit or device can be a viable approach to rapidly driving the transport current 12 to zero due to the afore mentioned relatively low, of the order or less than several volts, terminal voltages, developed in the NI magnets during the quench.

Thus, in FIG. 1 is shown a NI magnet. The NI magnet includes a superconducting coil having electrical terminals for coupling to a power supply, wherein receipt of a current from the power supply through the electrical terminals causes the superconducting coil to generate a magnetic field. The NI magnet may include a heating element disposed in proximity to a portion of the superconducting coil, wherein operation of the heating element causes the portion to lose its superconducting characteristic and become resistive, thereby inducing a quench of the NI magnet. In other embodiments, the NI magnet can be quenched without the use of a heating element, by driving the transport current to zero.

Moreover, in connection with FIG. 1 is also described a method to induce quench of an energized no-insulated (NI) magnet, the NI magnet comprising a superconducting coil. The method may comprise turning off the power supply 10, or opening the circuit breaker 15 or switch 15′. In some embodiments, the method comprises heating a portion of the superconducting coil above its critical temperature to cause the portion to lose its superconducting characteristic and become resistive, thereby interrupting a superconducting current path through the superconducting coil.

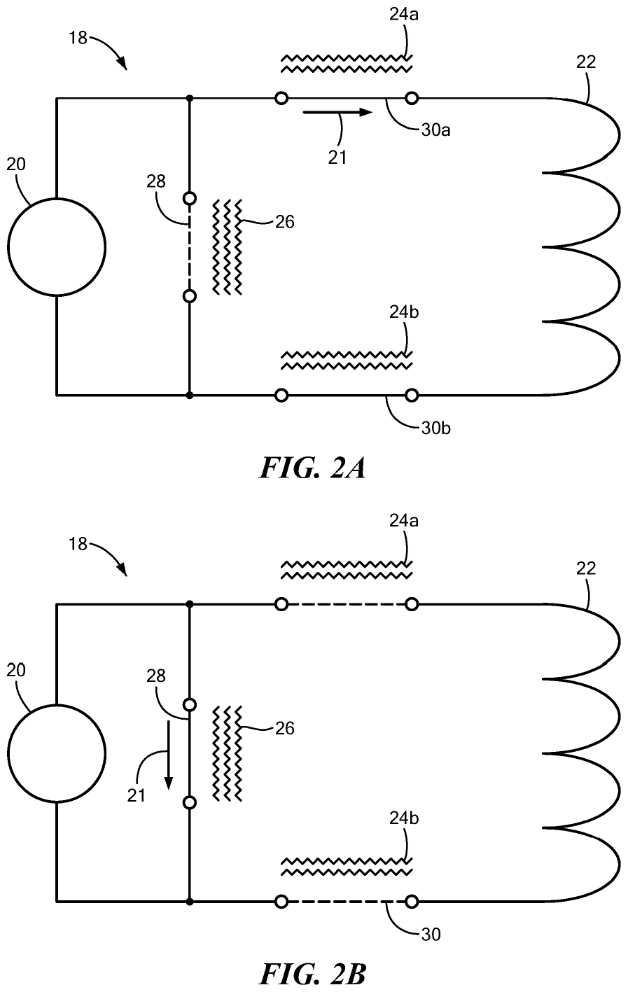

Referring now to FIGS. 2A and 2B, in which like numbers denote like elements, shown is a no-insulation (NI) magnet 18 according to an embodiment. The magnet 18 is coupled to a current (or power) supply 20 that provides an operating or transport current 21 to an NI magnet coil 22 for generating a magnetic field. Supply 20 and NI magnet coil 22 may be the same as or similar to source 10 and magnet 14 described above in conjunction with FIG. 1. A superconducting bypass element 28 is a shunt comprising a wire or cable coupled between leads or electrical terminals of NI magnet coil 22 that are coupled to the supply 20. The system further comprises heating elements (or simply, heaters) 24a, 24b and cooling element (or simply, cooler) 26 coupled to, or disposed in proximity to, superconducting wires 30a, 30b, 28 respectively. The heaters 24a, 24b and the cooler 26 are synchronized in operation. In embodiments, elements 24a, 24b are cryogenically cold when not operating, and hence superconducting wires 30a, 30b are also cryogenically cold.

With this system, another method to accomplish rapid shutdown is by using heaters 24a, 24b and cooler 26 to induce a quench. During normal operation (FIG. 2A) transport current is supplied via supply 20 to NI magnet coil 22 via superconducting current paths that include superconducting wires 30a, 30b, which are below their critical temperature and thus are exhibiting superconducting characteristics. Bypass element 28 comprises a superconducting wire. The bypass element 28 has a temperature above a superconducting critical temperature of the superconducting wire during normal operation, thus the bypass element 28 is resistive. Accordingly, in this operating mode, the bypass appears as an open circuit with respect to source 20 and hence, substantially no current flows through the bypass element 28.

In FIG. 2B is shown the state of the magnet 18 during a quench induced to cause a magnet shutdown, especially an emergency shutdown in accordance with embodiments. As illustrated in FIG. 2B, to induce the quench via bypass element 28, a resistive portion of bypass element 28 is cooled to a temperature at or below its critical temperature, bypass element 28 loses its resistive characteristic and becomes superconducting. Therefore, the bypass element 28 is herein referred to as a superconducting bypass even though it is not always in a superconducting state. Subsequently, one or more of the superconducting wires 30a, 30b are heated (as also described above in connection with FIG. 1), so that a portion of the superconducting coil loses its superconducting characteristic and becomes resistive. In embodiments, the cooling of bypass element 28 occurs before, or concurrently with, the warming or heating of superconducting materials in wires 30a, 30b (e.g. via operation of heating elements 24a, 24b or both) to make the superconducting wires 30a, 30b resistive. In any event, significantly, bypass element 28 should be cooled into superconductivity before wires 30a, 30b are heated above their respective critical temperatures and lose their superconducting properties and become resistive, so that the electrical circuit containing the magnet 18 and the supply 20 is never in an open state.

As a result of this operation, current provided by supply 20 is diverted from going through magnet coil 22 to a parallel path provided by the now superconducting bypass element 28. That is, since bypass element 28 is now superconducting while the wires 30a, 30b are now resistive, the former has a resistance characteristic which is smaller than a path through the latter so current will flow through the bypass element 28 rather than the magnet coil 22. Once this current has been diverted, the power supply 20 may be turned off without risking damage to the magnet 18, especially the magnet coil 22. In embodiments, a single superconducting wire may provide a transport current to the magnet rather than two separate superconducting wires, as in FIGS. 2A and 2B. For example, superconducting wire 30b may be omitted.

Thus, in FIG. 2 is shown an NI magnet like that shown in FIG. 1, but further including a resistive bypass wire coupled between the electrical terminals of the superconducting coil, and a cooling element disposed in proximity to the resistive bypass wire, wherein operation of the cooling element causes the resistive bypass wire to lose its resistive characteristic and become superconducting.

Moreover, in connection with FIG. 2 is described a method to induce quench of an energized no-insulated (NI) magnet, the NI magnet comprising a superconducting coil having electrical terminals. The method includes cooling a resistive bypass wire, coupled between the electrical terminals, below its critical temperature to cause the resistive bypass wire to lose its resistive characteristic and become superconducting, thereby providing a superconducting current path in parallel to a superconducting current path through the superconducting coil. The method then includes heating a portion of the superconducting coil above its critical temperature to cause the portion to lose its superconducting characteristic and become resistive, thereby interrupting a superconducting current path through the superconducting coil. In this way, cooling of the resistive bypass wire occurs before heating the portion of the magnet coil above its critical temperature. Both the cooling of the resistive bypass wire and the heating of the portion of the superconducting coil may occur with a given period of time, e.g. seconds or tens of seconds, thereby facilitating a rapid or emergency shutdown of the magnet.

The scheme described above in conjunction with FIG. 1 is relatively simple (compared with other quench control schemes such as that described in FIG. 2) and can be used in stand-alone NI magnets. The scheme described above in conjunction with FIG. 2 is more complex (e.g. compared with other quench control schemes such as that described in FIG. 1) but more universal. It can be used for quenching a single magnet in a system of magnets connected in series and energized by a single common power supply. Note that the efficiency, safety and reliability of operations of both schemes is facilitated by low terminal voltage, developed during the quench.

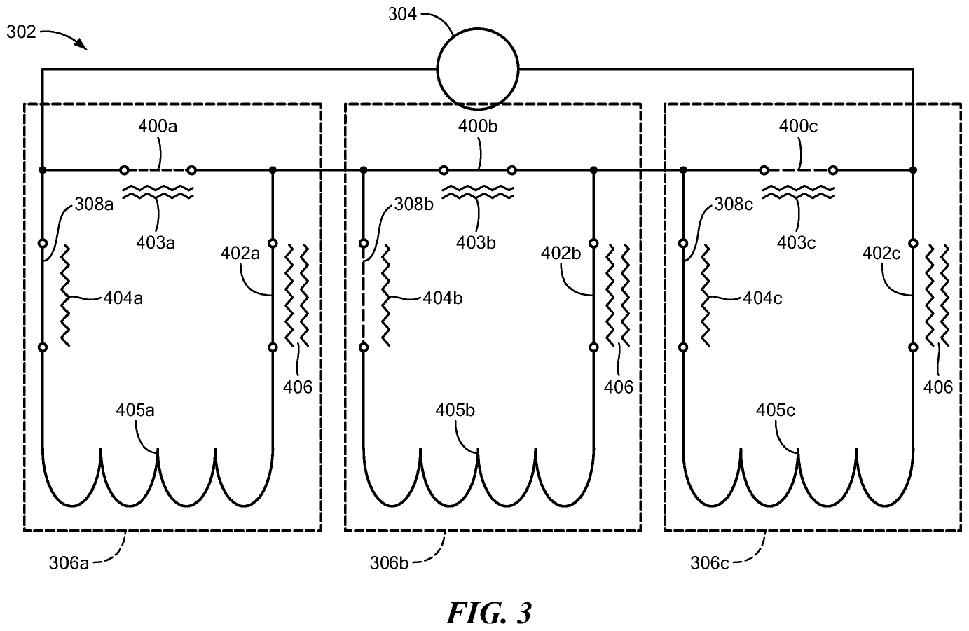

An embodiment 302 having three magnets connected in series is shown in FIG. 3. In normal operation, the power source 304 supplies power to the three NI magnets 306a, 306b, 306c, each of which may be the same as or similar to the NI magnet 18 of FIG. 2. Thus, when bypass wires 400a, 400b, 400c are open (disconnected) and coil supply wires 308a, 402a, 308b, 402b, 308c, 402c are closed (connected), current from the power source 304 flows through the coils 405a, 405b, and 405c.

In FIG. 3, the magnet 306a depicted on the left and magnet 306c depicted on the right are in normal operation. However, the magnet 306b in the middle is shown in the aforementioned fast shutdown mode. Accordingly, the bypass wire 400b is closed and the wire 308b is open, so that current entering the magnet 306b from magnet 306a passes through the bypass wire 400b, rather than the coil 405b. This arrangement may be accomplished in two steps. First, the bypass wire 400b is cooled from a normally conducting state to a superconducting state using the cooler 403b, providing a second superconducting current path in parallel with the coil 405b and thereby diverting a portion of the current across the bypass. Second, the coil supply wire 308b is heated from a superconducting state to a normally conducting state using the heater 404b, severing the current path through the coil 405b and thereby diverting the remaining current through the bypass wire 400b. In FIG. 3, the heaters 404a, 404c, 406 and coolers 403a, 403c are not operating.

In the embodiment shown in FIG. 3, a system heating element (or simply, system heater) 406 is provided with three heating elements, one for each of the three magnets 306a, 306b, 306c in series. The system heater 406 as shown may be used to simultaneously heat, and thereby interrupt an electrical current passing through each of, the coil supply wires 402a, 402b, 402c, thus enabling emergency shutdown of all magnets at once. By contrast, three heaters 404a, 404b, 404c are provided to enable emergency shutdown of any selected combination of the magnets, yielding operational flexibility. Although not shown in FIG. 3, it is appreciated that means may be provided to simultaneously operate the coolers 403a, 403b, 403c to thereby simultaneously provide bypass current paths for all magnets during a system-wide shutdown.

It is appreciated that alternate embodiments may use separately-controlled heating elements that are not part of a single heater 406 for this purpose. It is also appreciated that means other than heaters and coolers may be used to open and close current paths to enable emergency shutdown of one or more magnets as discussed above, including the use of switches, relays, or other known circuitry. It is further appreciated that other embodiments may use more or fewer magnets in series, and thus that the depiction in FIG. 3 of exactly three magnets 306a, 306b, 306c should not be viewed as limiting the concepts, techniques, and structures disclosed herein.

Thus, in FIG. 3 is shown a NI magnet system 302 comprising a plurality of NI magnets 306a, 306b, 306c coupled in electrical series. Each NI magnet in the system comprises the components of the NI magnet shown in FIG. 2; that is, a superconducting coil, a heating element disposed in proximity to a portion of the coil, a resistive bypass wire coupled between the electrical terminals, and a cooling element disposed in proximity to the bypass wire.

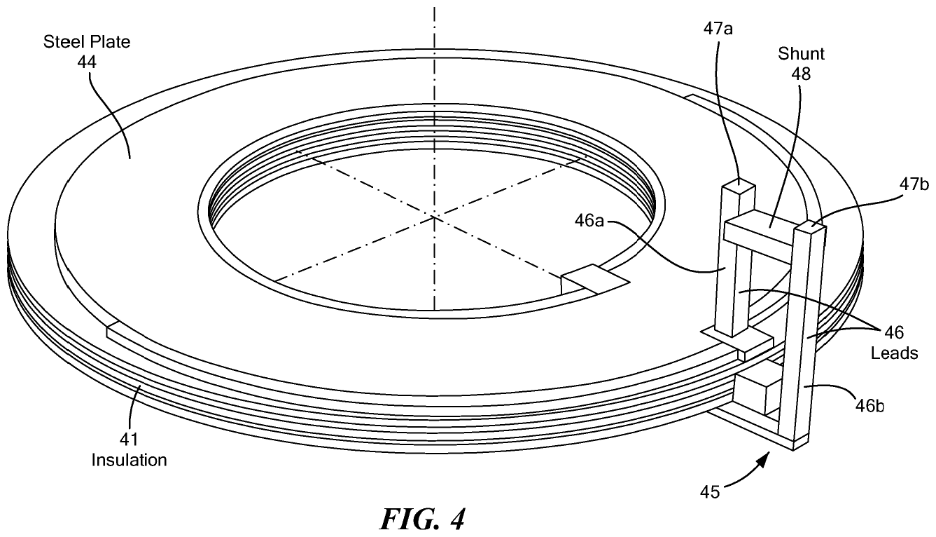

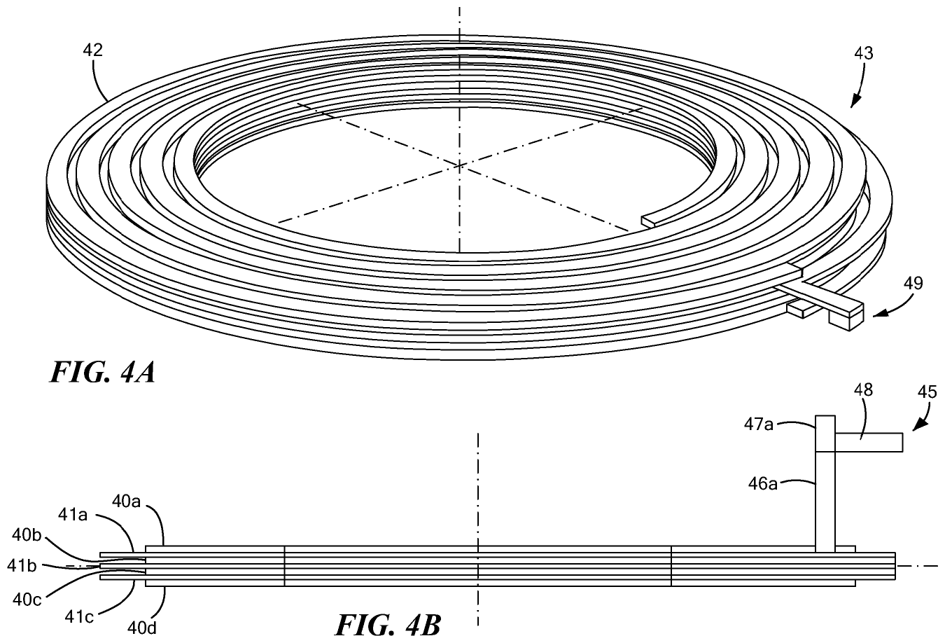

A series of numerical, finite element (FE) models were analyzed to illustrate the mechanisms and confirm the viability of this mode of operation. A generic FE model is shown in FIGS. 4-4B in which like elements are provided having like reference designations throughout the several views. The model is comprised of four NI pancakes 40a-40d (most clearly seen in FIG. 4B), separated by pancake-to-pancake insulation 41a-41c (most clearly seen in FIG. 4B and generally denoted 41 in FIG. 4). In this example embodiment, pancakes 40a, 40d correspond to a pair of outermost pancakes in the NI magnet.

In each pancake 40a-40d, a superconductor 42 forms a spiral 43 embedded into an electrically resistive matrix 44 (e.g. shown as an electrically resistive steel matrix or plate in the example of FIGS. 4-4B). The electrically resistive matrix 44 may act as a heat sink during an induced quench of the NI magnet. Electrically resistive matrix 44 is electrically conductive and can provide a bypass current path.

A bypass circuit 45 (which may be the same as or similar to bypass circuits 28 described above in conjunction with FIGS. 2A-2B) is coupled to the NI magnet via current leads 46a, 46b (collectively “current leads 46”). Thus, bypass circuit 45 comprises a superconducting shunt path 48 coupled between current leads 46 and the NI magnet via terminals 47a, 47b of the current leads 46a, 46b, respectively.

Superconducting wires 42 (most clearly visible in FIG. 4A) are wound in a spiral shape to form spirals of superconducting wires 43 (most clearly visible in FIG. 4A) which are sequentially electrically coupled in the manner described below:
to the first current lead at the outside diameter (“OD”) of pancake 40a;
between inside diameter (“ID”) of pancake 40a and ID of pancake 40b;
between OD of pancake 40b and OD of pancake 40c;
between ID of pancake 40c and ID of pancake 40d;
to the second current lead at the OD of pancake 40d,
   forming a superconducting current path of the magnet.

At the initial time point, t=0, operating transport current is supplied to the NI magnet through current leads 46a, 46b and is carried exclusively via the superconducting current path with zero (or substantially zero) current flowing transversely between the turns of the same or adjoining one of pancakes 40a-40d.

During a fraction of a second, the second mode of quench initiation was modeled by reducing resistivity of the shunt path 48 to essentially zero and then increasing resistivity of the leads to a resistance value which is typical for a normal conductor (i.e. a conductor that does not have a superconducting characteristic). The structure identified by reference numeral 49 represents a transition between OD ends of the winding of pancakes 40b and 40c.

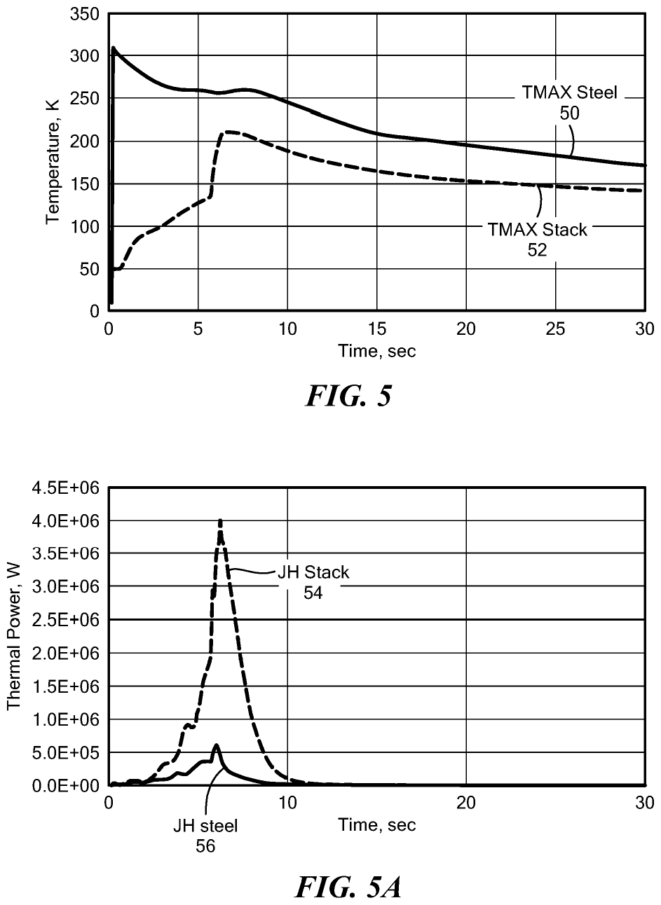

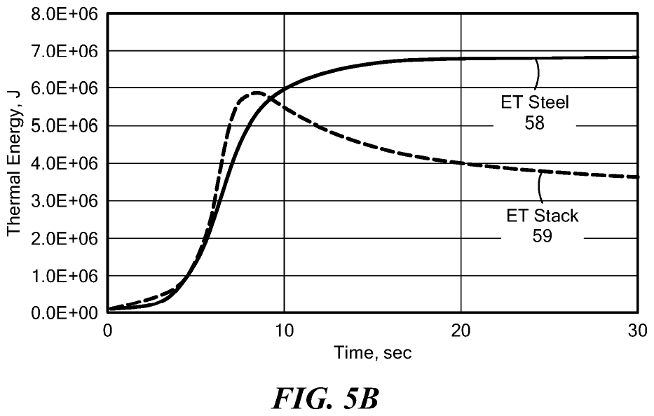

Referring now to FIGS. 5-5B, the model described in conjunction with FIGS. 4-4B was run for 30 seconds and shown are the peak temperature (FIG. 5), generated heat (FIG. 5A) and accumulated thermal energy (FIG. 5B) vs. time for the superconductor (as indicated by curves 52, 54, 59) and the steel matrix (as indicated by curves 50, 56, 58).

Monitoring these parameters over the time of the quench indicates that quench occurs due to resistive heating of the resistive matrix of the pancakes by transverse currents, spread over a significant azimuthal span between the OD and ID ends of the superconducting spiral.

As can be seen in FIG. 5A, peak heating power deposition is reached at or about a time of t=6.2 seconds, by which time the superconducting wire is above its critical temperature in the whole NI magnet.

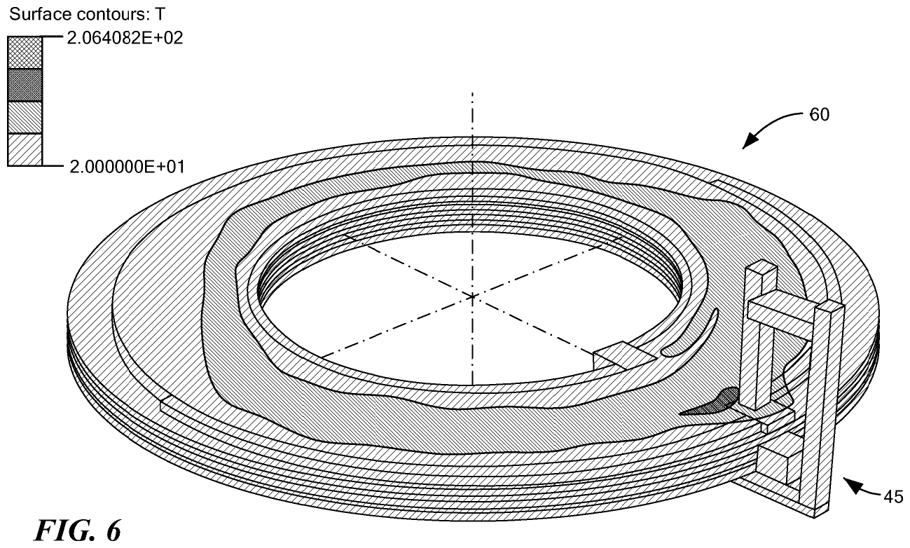

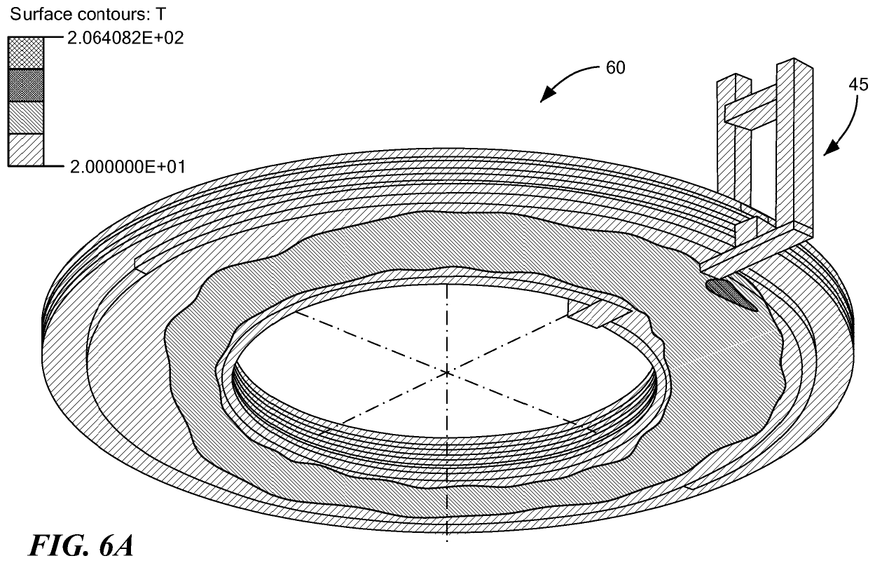

FIGS. 6 and 6A show top and bottom views, respectively, of a temperature distribution in an NI magnet 60 (which may be the same as or similar to NI magnets 14, 18 described above in conjunction with FIGS. 1 and 2) at the end of the quench. As can be seen in FIGS. 6, 6A, significant temperature rises (i.e. hot spots of about 300° K) exist after quench initiation (and in some cases immediately after quench initiation), between the OD turns of the outermost pancakes near points where current leads are electrically coupled to the superconducting spiral wire. The reason for this phenomenon is as follows. Once the transport current flowing to the NI magnet via the current leads (e.g. paths 30a, 30b in FIGS. 2-2A) goes to zero, the above-described process of changing the pattern of the current from spiral to transverse begins, leading to a reduction (and in some cases a dramatic reduction) of the field of the NI magnet and the flux captured in the superconducting spiral. Following Maxwell's laws, induced eddy currents try to conserve the magnetic flux. These eddy currents are primarily generated in the outermost turn of the superconducting spiral which form a pancake. However, since this spiral turn is coupled to the aforementioned current lead, this spiral turn is not continuous. Rather, it is open at the connection (or entry) point of the current lead. The current loop has only one way to close; namely, by bridging the ends of the outermost superconducting turn through the resistive material of the matrix. This current loop leads local resistive heating of the resistive matrix. Such local resistive heating may occur rapidly, (e.g. immediately after the initiation of the quench sequence), and may result in high, in excess to 250 K, temperatures in a given location.

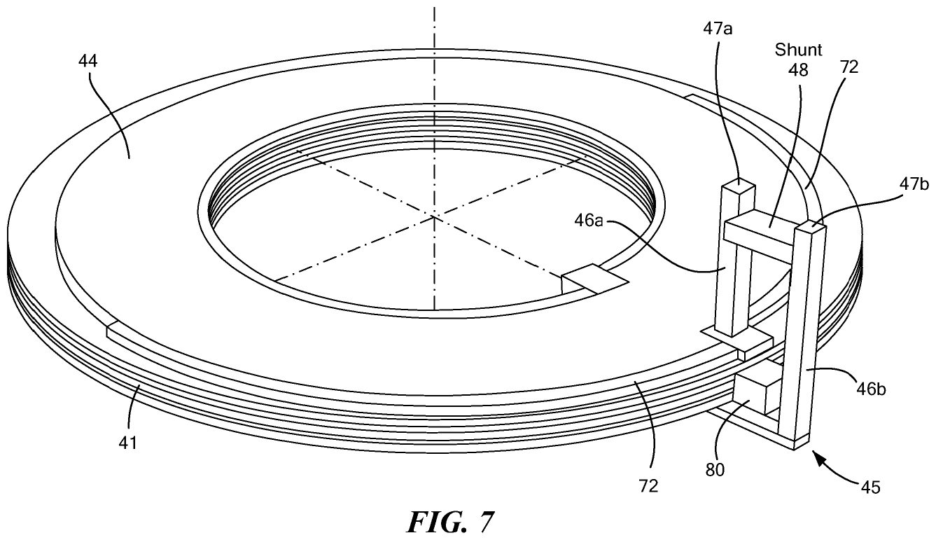

There can be multiple ways of mitigating this excessive local heating. One way is described in conjunction with FIG. 7. Referring now to FIG. 7, in which like elements of FIGS. 4-4B are provided having like reference designations, a portion of an NI magnet comprises an electrically conductive plate 44 disposed over one or more pancakes (not visible in FIG. 7). An electrically conductive structure 72 is disposed around at least a portion of one or more pancakes and is adjacent to and in electrical contact with plate 44 embracing the interruption in a superconducting structure which forms the pancake at its outside diameter (“OD”).

In embodiments, the conductive structure 72 may be disposed about a portion of a pancake. In one example embodiment, the electrically conductive structure 72 may be provided as an electrically conductive cladding provided around an outer portion of a pancake. In one example embodiment, the electrically conductive structure 72 may be provided as an electrically conductive cladding provided around a portion of an outside diameter (OD) of a pancake. In embodiments, the cladding may be disposed about a portion of an outermost pancake. In embodiments, the cladding may be disposed about a portion of an OD of a pancake. In embodiments, the cladding may be disposed about an outermost portion of a superconducting wire of a pancake. For example, the cladding may be disposed about an outermost portion of a superconducting spiral-wound wire which forms the pancake.

In embodiments the cladding 72 may be added or otherwise provided to the OD end of a spirally wound superconducting wire, embracing the interruption in the spiral of the superconducting wire at its OD (i.e. where the end of the superconducting wire is coupled to a terminal such as one of terminals 46a, 46b). The cladding 72 can thus embrace (e.g. be disposed over) the OD spiral end all the way around it or can optionally extend azimuthally only over partial perimeter portions, as illustrated in FIG. 7.

In embodiments the cladding 72 may be provided as a copper cladding. Other materials, including, but not limited to aluminum and brass, may of course, also be used.

With the above described structures, quench may be accomplished by providing a bypass signal path having a relatively low resistance (e.g. a resistance characteristic which is relatively low compared with the resistance characteristic of a transverse path in an insulated magnet) for induced currents around the OD end of a winding. In embodiments, the bypass path may be comprised of any electrically conductive material including, but not limited to, copper, aluminum or brass to name but a few example materials. With respect to the particular example embodiment of FIG. 7, quench may be accomplished by providing a bypass path for induced currents around the OD end of the pancake, e.g. for induced currents around the OD end of the spiral of the superconducting wire. The cladding 72 embraces the interruption in the spiral of the superconducting wire at its OD. The structure identified by reference numeral 80 represents a transition between OD ends of the winding of the illustrated pancakes.

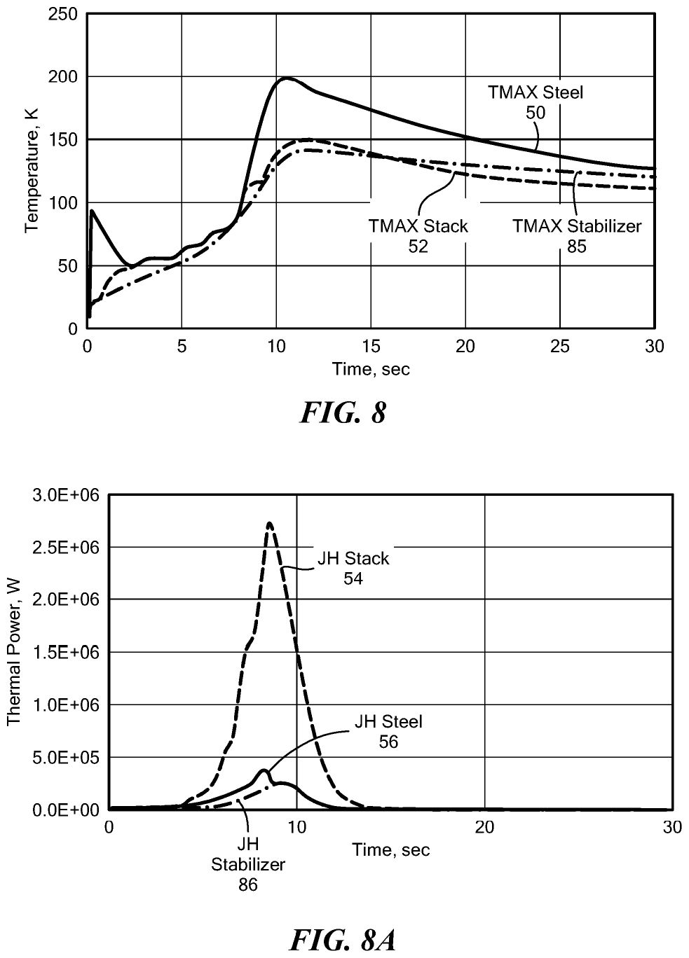

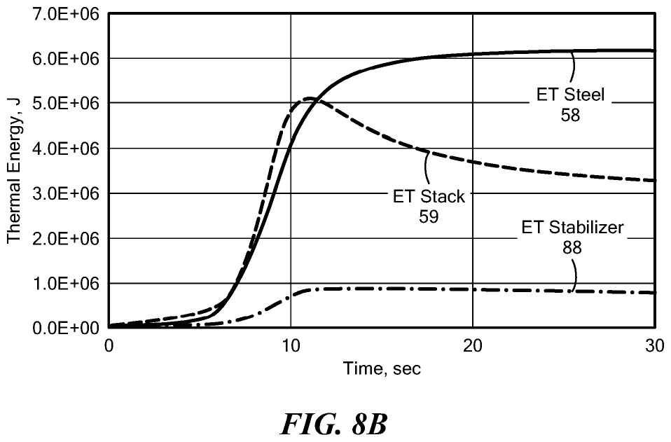

Referring now to FIGS. 8-8B, shown are a series of plots illustrating peak temperature (FIG. 8), generated heat (FIG. 8A) and accumulated thermal energy (FIG. 8B), separately for a superconductor, a steel matrix and a stabilizer (which in this example is provided as copper cladding). For this model, initial temperature rise, as well as maximum over the time of the quench temperature both in the superconductor, in the steel matrix and the copper cladding (identified as stabilizer curves 85, 86, and 88 in FIGS. 8-8B) are significantly lower than without cladding 72. Peak heating power deposition is also reduced. The total thermal energy at the end of the quench is equal to the initial electromagnetic energy, which in both cases is the same.

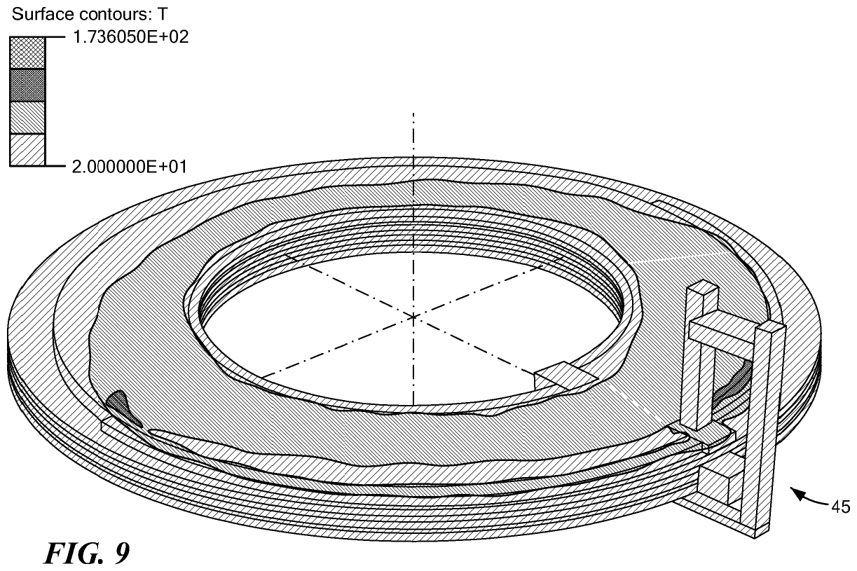

FIG. 9 shows temperature distribution at the end of a quench in an NI magnet having copper cladding. While hot spots still exist, the temperature is lower and the hot spots are not as localized compared to embodiments without copper cladding (e.g. as shown in FIGS. 6, 6A) because the cladding rapidly and spatially redistributes the excess heat.

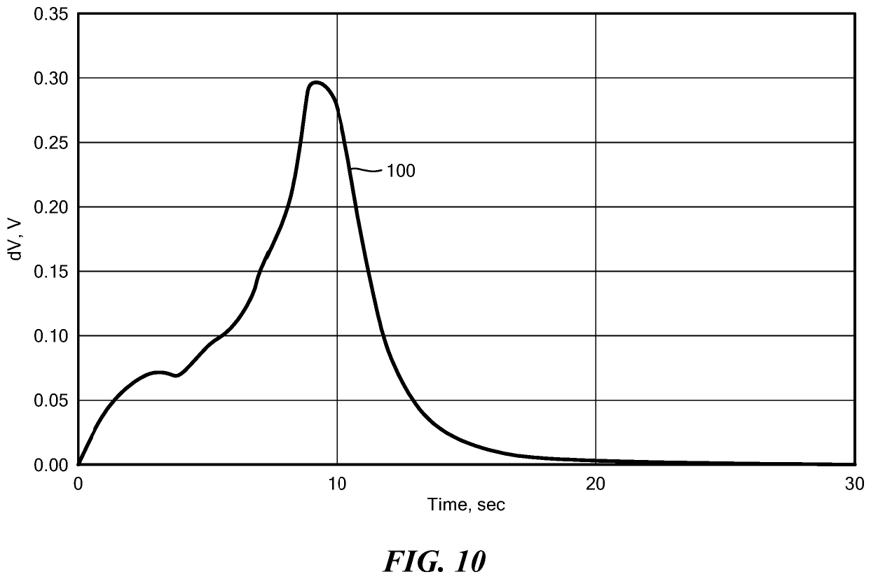

FIG. 10 depicts evolution of the terminal voltage over the time of the quench in an NI magnet. It should be noted that in this case, as can be seen from curve 100 the terminal voltage stays well below one (1) volt, even at its peak.

A simplified representation of an NI scheme may be illustrated by presenting it as a set of parallel superconducting cables installed in a thin (e.g., of the order or less than several (e.g. 5) centimeters), matrix having finite electrical resistivity at the operating cryogenic temperature below 77 K. In embodiments, the matrix has a resistivity characteristic ranging between those of copper and steel or other structural materials including but not limited to Inconel®, Nitronic® 40, Nitronic® 50, Incoloy®, or combinations thereof. Electrical conductivity is established between these two components.

In embodiments, the approach to a fast discharge of NI magnets described herein, especially in connection with FIGS. 1-10, may be applied to an NI magnet comprised of a cable arranged in such a way that there is no continuous turn-to-turn insulation, which permits limited turn-to-turn current sharing. There are two generic categories of NI magnets as described in conjunction with FIGS. 11-14 and 15-17, respectively.

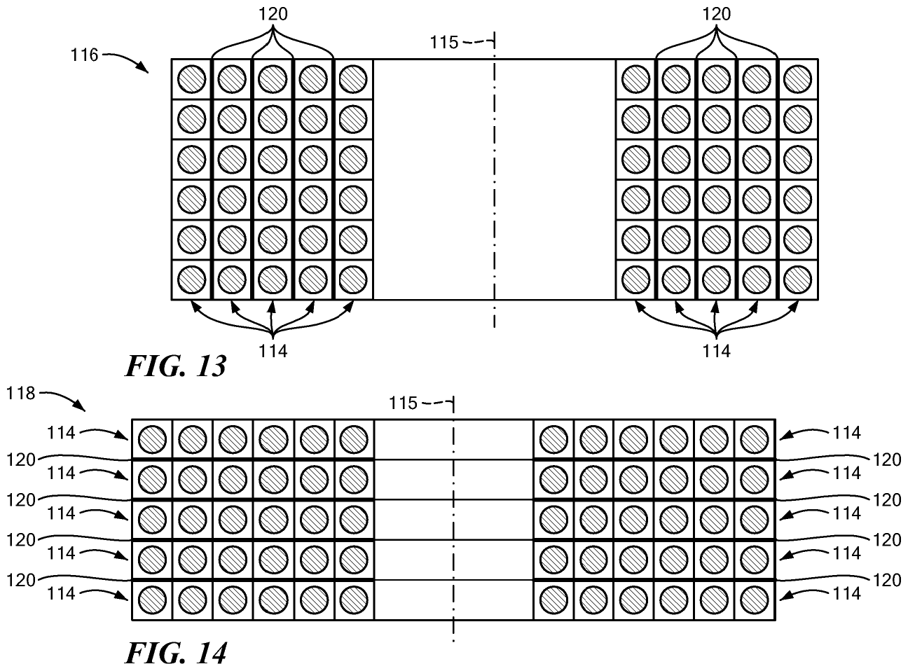

In a first category, magnets may be wound from a superconducting cable without turn-to-turn insulation (e.g. as will be described in conjunction with FIG. 11) to form a wound layer having a generally rectangular cross section (e.g. as will be described in conjunction with FIG. 12). In the case where a superconducting magnet is wound from a superconducting cable without turn-to-turn insulation, turns of the superconducting cable are typically wound in a layer-wound arrangement (e.g. as illustrated in FIG. 13) or in a pancake-wound arrangement (e.g. as illustrated in FIG. 14). A layer of insulation may be disposed or otherwise provided between respective ones of the layers (or pancakes) formed by the no-insulation winding of the cable.

Referring now to FIG. 11, in a first category, magnets may be wound from a cable 110 without turn-to-turn insulation. In this case, turns of the cable 110 are wound to form a wound layer having a rectangular cross-sectional shape 114 as illustrated in FIG. 12. These wound layers may be further wound in a layer-wound arrangement 116 (FIG. 13, which shows five cylindrical layers of six wires each), or in a pancake-wound arrangement 118 (FIG. 14, which shows five stacked pancakes having six wires each). A layer of insulation 120 may be disposed or otherwise installed between respective ones of the layers having cross-section 114 (or pancakes having cross-section 114) formed by the no-insulation winding of the cable. The above description focuses on the relationship between the orientation of the layers or pancakes with respect to a central longitudinal axis of the magnet (shown as axis 115 in FIGS. 13, 14, and 16-21).

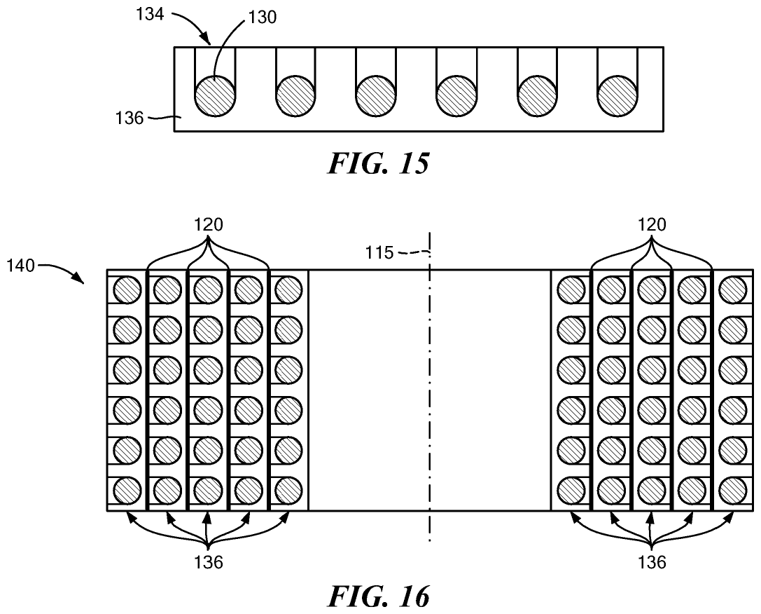

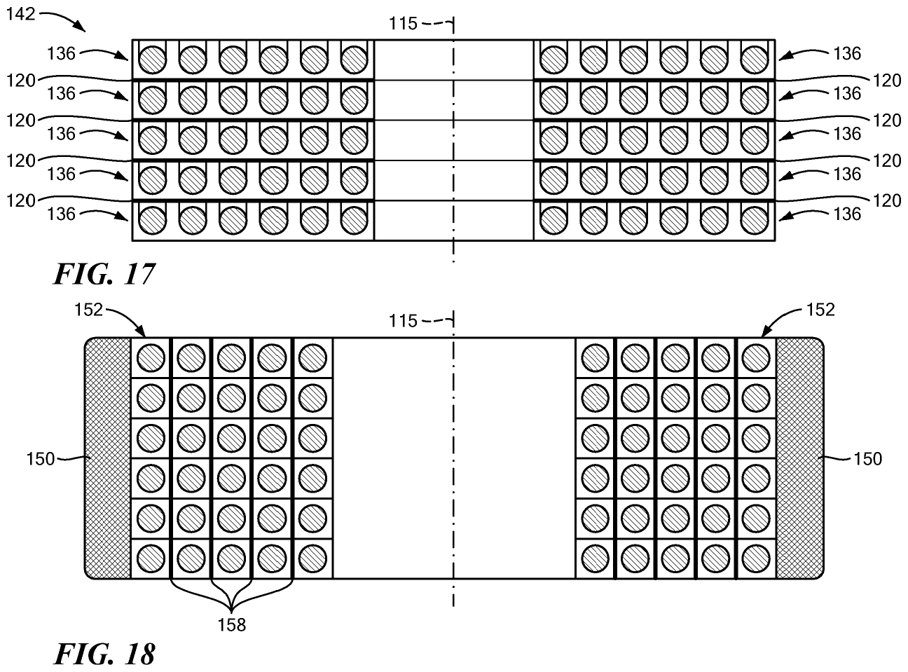

In a second category, magnets may comprise a superconducting cable inserted or otherwise disposed in a groove or opening in a structural shell (e.g. as will be described in conjunction with FIG. 15). The structural shells can be arranged in a multi-layered or multi-pancake arrangement of a layer-wound scheme (e.g. as illustrated in FIG. 16) or a pancake-wound scheme, (e.g. as illustrated in FIG. 17). However, regardless of the specific NI magnet implementation, the approach to achieve a fast discharge of NI magnets described herein may be used. In embodiments, the magnet may include layers (or pancakes) with insulation and layers (or pancakes) without insulation. In embodiments, a layer of insulation may be disposed or otherwise installed between at least two of the layers 114 (or pancakes 114).

Referring now to FIG. 15, in a second category, magnets may comprise a superconducting cable 130 inserted or otherwise disposed in an opening or groove 134 of a structural shell 136. A plurality of such structural shells 136 can be arranged in a multi-layered arrangement 140 of a layer-wound scheme (e.g. as illustrated in FIG. 16) or a multi-pancake arrangement 142 of a pancake-wound scheme (e.g. as illustrated in FIG. 17). As also described above, a layer of insulation 120 may be disposed or otherwise installed between respective ones of the layers having cross-section 136 (FIG. 16) or pancakes having cross-section 136 (FIG. 17) formed by the no-insulation winding of the cable.

In general, high-field superconducting magnets often comprise multiple cable turns grouped in a multi-layer arrangement (i.e. the magnets are comprised of multiple layers). The turns may be closely spaced. In embodiments in which a high-field superconducting magnet is formed by cable turns arranged in flat layers (e.g. such that contacting surfaces of the layers are orthogonal to a central longitudinal axis of the magnet about which the layers are disposed), such an arrangement may be referred to as “a pancake-wound arrangement,” or simply “pancake-wound” or even more simply “a pancake.” Examples of a pancake-wound arrangement are shown in FIGS. 14, 17, 20, and 21. If a magnet is formed by layers with turns (e.g. such that contacting surfaces of the layers are parallel to a central longitudinal axis of the magnet about which the layers are disposed), such an arrangement may be referred to as a “a layer-wound scheme” or simply “a layered configuration” or even more simply “layered.” Examples of a layer-wound scheme are shown in FIGS. 13, 16, 18, and 19.

After reading the disclosure provided herein, persons having ordinary skill in the art will appreciate other embodiments of the concepts, devices, and techniques disclosed herein. It should thus be appreciated that superconducting magnets configured according to the concepts and techniques described herein may be useful for a wide variety of applications. For example, it should be appreciated that stacked layers can be of an arbitrary shape. For example, the stacked layers (e.g. comprising no-insulation cable in a matrix) can be of an arbitrary shape as may be utilized in a stellarator. In such applications, it should be appreciated that the concepts, systems and techniques described herein related to emergency shutdown, may be used.

The principles of the concepts, techniques, and structures described above in conjunction with FIGS. 4-10 for mitigating excessive local heating in pancake-wound NI magnets can be applied to a wide variety of NI winding schemes including, but not limited to those described herein.

One technique to implement this concept may, for example, include providing a relatively low resistance bypass signal path (i.e., a signal path having a resistance characteristic which is lower than a resistance characteristic of a transverse path in an insulated magnet) for induced currents around an outside diameter (OD) end of the spiral of the superconducting wires. This may be accomplished, for example, by adding an electrically conductive element (e.g. an electrically conductive cladding such as a copper cladding), embracing the interruption in the spiral of the superconducting wire at its OD. Thus, it is appreciated that the concepts, techniques, and structures shown in FIGS. 4-10 and described above may be used to mitigate excessive local heating during emergency shut down of any of the superconducting magnet arrangements shown in FIGS. 11-17 and described above.

FIGS. 18-21 generally illustrate locations of additional electrically conductive elements (which may, for example, be provided as a conductor such as a cladding of copper or other low-resistivity material) for the above-mentioned NI winding schemes. In embodiments, the conductor is provided having a low-resistivity characteristic (i.e. a resistance characteristic which is relatively low compared with the resistance characteristic of a transverse path in an insulated magnet).

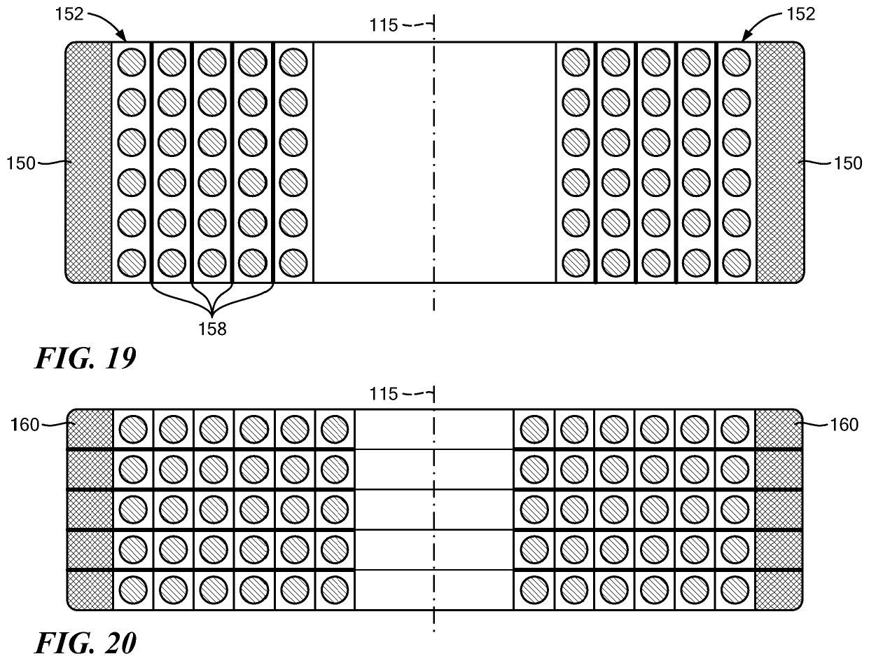

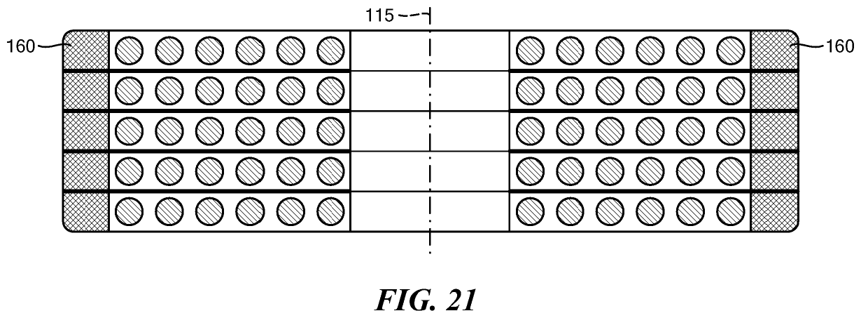

FIGS. 18 and 19 show that in layer-wound embodiments (both with an NI cable and cable in the matrix), a conductor may be disposed or otherwise provided at the OD of, or in line with, the outermost turn of the spiral winding. Optionally, a conductor may be disposed or otherwise provided between the layers. In either case, the conductor is electrically continuous in the circumferential direction and is insulated from the electrically conducting matrix of the forming layers. FIGS. 20 and 21 illustrate that in pancake-wound embodiments (both with an NI cable and cable in the matrix), a conductor may be disposed or otherwise provided at the OD of some or all pancakes.

Referring now to FIG. 18, an NI magnet comprises an NI cable arranged in a layer-wound configuration. A conductor 150 (e.g. copper) may be coupled to (e.g. via a cladding technique) or otherwise provided or arranged at the OD of the outermost layer (with the outermost layers in FIG. 18 identified with reference numeral 152). Optionally, a conductor (e.g. copper cladding 158) can be installed or otherwise disposed or provided between the layers. In either case, the conductor 150 should be electrically insulated from the layers forming the electrically conducting matrix. The conductor 150 provides a relatively low resistance bypass signal path (i.e., a signal path having a resistance characteristic which is lower than a resistance characteristic of a transverse path in an insulated magnet) for induced currents around an outside diameter (OD) end of a spiral of the superconducting wires.

Referring now to FIG. 19, an NI magnet comprises an NI cable arranged in a matrix with the NI cable arranged in a layer-wound configuration. A conductor 150 (e.g. a copper cladding) may be coupled to or otherwise provided or arranged at the OD of the outermost layer (with the outermost layers in FIG. 19 being identified with reference numeral 152). Optionally, a conductor (e.g. copper cladding 158) can be installed or otherwise disposed between the layers. In either case, the conductor 150 should be electrically insulated from the layers forming the electrically conducting matrix. The conductor 150 provides a relatively low resistance bypass signal path (i.e., a signal path having a resistance characteristic which is lower than a resistance characteristic of a transverse path in an insulated magnet) for induced currents around an outside diameter (OD) end of a spiral of the superconducting wires.

Referring now to FIG. 20, an NI magnet comprises a NI cables arranged in a pancake-wound embodiment, and a conductor 160 (e.g. a copper cladding) may be coupled to or otherwise provided or disposed at the OD of some or all pancakes. Examples are described in detail hereinabove in conjunction with at least FIGS. 4-10. The conductor 160 provides a relatively low resistance bypass signal path (i.e., a signal path having a resistance characteristic which is lower than a resistance characteristic of a transverse path in an insulated magnet) for induced currents around an outside diameter (OD) end of the pancakes

Referring now to FIG. 21, an NI magnet comprises NI cables with cables in a matrix and the NI cables arranged in a pancake-wound embodiment. A conductor 160 (e.g. a copper cladding) may be coupled to or otherwise provided or disposed at the OD of some or all pancakes. Examples of pancake embodiments are described in detail hereinabove in conjunction with at least FIGS. 4-10. The conductor 160 provides a relatively low resistance bypass signal path (i.e., a signal path having a resistance characteristic which is lower than a resistance characteristic of a transverse path in an insulated magnet) for induced currents around an outside diameter (OD) end of the pancakes.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the concepts described herein are not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure “A” over element or structure “B” include situations in which one or more intermediate elements or structures (e.g., element “C”) is between element “A” and element “B” regardless of whether the characteristics and functionalities of element “A” and element “B” are substantially changed by the intermediate element(s).

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a method, article, or apparatus that comprises a list of elements is not necessarily limited to only those elements but can include other elements not expressly listed or inherent to such method, article, or apparatus.

Additionally, the term “exemplary” is used herein to mean “serving as an example, instance, or illustration.” Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment,” “an embodiment,” “an example embodiment,” or variants of such phrases indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection knowledge of one skilled in the art to affect such feature, structure, or characteristic in connection with other embodiments whether or not explicitly described.

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” surface can become a “lower” surface simply by turning the object over. Nevertheless, it is still the same surface and the object remains the same. Also, as used herein, “and/or” means “and” or “or”, as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements.

Having described exemplary embodiments, it will now become apparent to one of ordinary skill in the art that other embodiments incorporating their concepts may also be used. For example, it should be appreciated that the emergency shutdown systems, circuits and techniques describe herein apply to all no-insulation coils and not just spiral groove embodiments. Furthermore, it may be possible to implement heater control (e.g. starting shut down via the heaters) in a manner different than that described herein above. For example, the same or similar functionality (e.g. opening/closing paths 28, 30a, 30b in FIGS. 2A, 2B) may be accomplished by switches (rather than heaters) capable of operating with the currents involved.

Accordingly, the embodiments contained herein should not be limited to disclosed embodiments, but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable sub-combination. Other embodiments not specifically described herein are also within the scope of the following claims.

1. (canceled)

2. A no-insulation (NI) magnet comprising:
a superconducting coil having electrical terminals for coupling to a power supply, wherein receipt of a current from the power supply through the electrical terminals causes the superconducting coil to generate a magnetic field;
a heating element disposed in proximity to a portion of the superconducting coil, wherein operation of the heating element causes the portion to lose its superconducting characteristic and become resistive, thereby inducing a quench of the NI magnet
a resistive bypass wire coupled between the electrical terminals of the superconducting coil; and
a cooling element disposed in proximity to the resistive bypass wire, wherein operation of the cooling element causes the resistive bypass wire to lose its resistive characteristic and become superconducting.

3-19. (canceled)

20. A no-insulation (NI) magnet system comprising a plurality of NI magnets coupled in electrical series, each NI magnet comprising:
a superconducting coil having electrical terminals for coupling to a power supply, wherein receipt of a current from the power supply through the electrical terminals causes the superconducting coil to generate a magnetic field;
a heating element disposed in proximity to a portion of the superconducting coil, wherein operation of the heating element causes the portion to lose its superconducting characteristic and become resistive, thereby inducing a quench of the NI magnet;
a resistive bypass wire coupled between the electrical terminals of the superconducting coil; and
a cooling element disposed in proximity to the resistive bypass wire, wherein operation of the cooling element causes the resistive bypass wire to lose its resistive characteristic and become superconducting.

21. The NI magnet system of claim 20, wherein the superconducting coil of at least one of the plurality of NI magnets comprises a superconducting cable wound against itself without turn-to-turn insulation to form a wound layer.

22. The NI magnet system of claim 21, wherein the superconducting coil of the at least one of the plurality of NI magnets comprises a plurality of wound layers in a layer-wound arrangement.

23. The NI magnet system of claim 22, the at least one of the plurality of NI magnets further comprising a layer of insulation disposed between respective ones of the plurality of wound layers in the layer-wound arrangement.

24. The NI magnet system of claim 21, wherein the superconducting coil of at least one of the plurality of NI magnets comprises a plurality of wound layers stacked in a pancake-wound arrangement.

25. The NI magnet system of claim 24, the at least one of the plurality of NI magnets further comprising a layer of insulation disposed between adjacently-stacked wound layers.

26. The NI magnet system of claim 20, wherein the superconducting coil of at least one of the plurality of NI magnets comprises a superconducting wire wound in a groove of a structural shell.

27. The NI magnet system of claim 26, wherein the superconducting coil of the at least one of the plurality of NI magnets comprises a plurality of superconducting wires, each superconducting wire wound in a groove of a respective structural shell, the structural shells arranged in a layer-wound arrangement.

28. The NI magnet system of claim 27, the at least one of the plurality of NI magnets further comprising a layer of insulation disposed between respective ones of the structural shells.

29. The NI magnet system of claim 26, wherein the superconducting coil of at least one of the plurality of NI magnets comprises a plurality of superconducting wires, each superconducting wire wound in a groove of a respective structural shell, the structural shells stacked in a pancake-wound arrangement.

30. The NI magnet system of claim 29, the at least one of the plurality of NI magnets further comprising a layer of insulation disposed between adjacently-stacked structural shells.

31. The NI magnet system of claim 20, wherein the superconducting coil of at least one of the plurality of NI magnets comprises a high temperature superconductor.

32. The NI magnet system of claim 20, at least one of the plurality of NI magnets further comprising a conductive structure for carrying thermal energy away from the electrical terminals during an induced quench of the NI magnet.

33. The NI magnet system of claim 32, wherein the conductive structure comprises a copper cladding.

34. The NI magnet system of claim 32, wherein the conductive structure is disposed about a portion of an outside or inside perimeter of the NI magnet.

35. The NI magnet system of claim 32, the at least one of the plurality of NI magnets further comprising an electrically resistive matrix retaining the superconducting coil.

36. The NI magnet system of claim 35, wherein the conductive structure is coupled to the electrically resistive matrix, and wherein the electrically resistive matrix acts as a heat sink during the induced quench of the NI magnet.

37. The NI magnet system of claim 35, wherein the electrically resistive matrix comprises steel.

38. The NI magnet system of claim 20, further including a system heating element comprising heating elements disposed in proximity to respective second portions of each of the NI magnets in the plurality, wherein operation of the system heating element simultaneously causes the respective second portions to lose their superconducting characteristics and become resistive, thereby inducing a simultaneous quench of each of the NI magnets in the plurality.

39. (canceled)

40. A method of inducing quench of a no-insulated (NI) magnet energized by a power supply, the NI magnet comprising a superconducting coil, the method comprising:
heating a portion of the superconducting coil above its critical temperature to cause the portion to lose its superconducting characteristic and become resistive, thereby interrupting a superconducting current path through the superconducting coil, and
cooling a resistive bypass wire, coupled between electrical terminals of the NI magnet, below its critical temperature to cause the resistive bypass wire to lose its resistive characteristic and become superconducting, thereby providing a superconducting current path in parallel to a superconducting current path through the superconducting coil.

41. The method of claim 40, wherein the cooling of the resistive bypass wire occurs before the heating the portion of the superconducting coil above its critical temperature.

42. The method of claim 40, wherein the cooling of the resistive bypass wire and the heating of the portion of the superconducting coil both occur within a given period of time.

43. The method of claim 40, further comprising turning off the power supply.

44. A method to induce quench in a no-insulated (NI) magnet having a pair of leads, the method comprising:
reducing a resistivity of a shunt path to substantially zero, wherein the shunt path is coupled between the pair of leads of the NI magnet; and
increasing resistivity of at least one of the pair of leads of the NI magnet to a resistance value comparable to a conductor having a normal resistance characteristic.

45-70. (canceled)
